(19) United States
(12) Patent Application Publication
(10) Pub. No.: US 2014/0165088 A1
(43) Pub. Date: Jun. 12, 2014

(54) IMAGE CAPTURE IN A VIDEO SIGNAL

(71) Applicant: NUMERICABLE, MARNE LA VALLEE Cedex 2 (FR)

(72) Inventors: Philippe Le May, Marne La Vallee Cedex 2 (FR); Stéphane Monnier, Marne La Vallee Cedex 2 (FR); Thierry Jolly, Marne La Vallee Cedex 2 (FR); Frédéric Defrance, Marne La Vallee Cedex 2 (FR); Antoine- Hubert Huart de Vernueil, Marne La Vallee Cedex 2 (FR)

(73) Assignee: NUMERICABLE, MARNE LA VALLEE Cedex 2 (FR)

(21) Appl. No.: 13/754,406

(22) Filed: Jan. 30, 2013

(30) Foreign Application Priority Data
Dec. 10, 2012 (FR) 1261842

(51) Int. Cl. H04N 21/4788

(52) U.S. Cl. CPC H04N 21/4788
USPC 725/25; 725/37

(57) ABSTRACT

A processing device for video signal includes a video buffer memory capable of storing a video signal currently being played back, a graphical interface generation module capable of generating a graphical interface to control functions of the processing device, a video mixer capable of producing a display signal for a display, the display signal representing a combination of the graphical interface originating from the generation module and of the video signal currently being played back originating from the video buffer memory, in which the graphic control elements include an image capture triggering element that can be displayed on the display in combination with the video signal currently being played back and that can be activated to trigger the step of selecting a section of the video signal currently being played back including an image displayed on the display at the time of the activation of the image capture triggering element.

The invention relates to the field of the processing of a video signal, in particular of a signal transmitted by a television channel, and to a device for processing such a signal, in particular a digital television network access box.

The digital television channels can be transmitted to the end receivers through various media, such as microwave broadcasting, cable or wire networks and cellular networks. The reception of a digital television signal, in particular when this signal is transported over a packet network, requires a certain number of processing operations such as demultiplexing, decoding and storing in buffer memory which are commonly performed in a processing module that can be incorporated in the television set or supplied in the form of a separate box, which will here be called access box. Given that such an access box can incorporate different functions, other names are also commonly used such as decoder, modem or set top box.

According to one embodiment, the invention provides a method for processing a video signal, comprising:

generating a graphical interface comprising graphic control elements that can be activated in response to activation signals, the graphic control elements comprising an image capture triggering element,
producing, for a display, a display signal representing a combination of the graphical interface and of a video signal currently being played back,
selecting a section of the video signal currently being played back in response to an activation of the image capture triggering element, the selected section of the video signal comprising an image of the video signal displayed on the display at the time of the activation of the image capture triggering element,
making the selected video signal section available in a memory.

According to other embodiments, such a method can have one or more of the following features.

The selected video signal section can comprise one or more images, with or without associated audio track. According to one embodiment, the selected video signal section consists of an image displayed on the display at the time of the activation of the image capture triggering element. According to one embodiment, the selected video signal section comprises a sequence of images beginning at an image displayed on the display at the time of the activation of the image capture triggering element. According to one embodiment, an audio sequence associated with the sequence of images is also selected in response to the activation of the image capture triggering element and made available in a memory. According to one embodiment, the sequence of images ends at an image displayed on the display at the time of a second activation of the image capture triggering element. According to one embodiment, the sequence of images ends at an image displayed on the display at the time of an activation of a second image capture triggering element.

According to embodiments, the memory in which the selected video signal section is made available is a random access memory module dedicated to this availability function or a random access memory module shared with other functionalities, in particular a video buffer memory.

According to one embodiment, the selected video signal section is made available in the memory in a raw image format. A raw image, also called digital negative, describes a family of image formats characterized by the fidelity to the signal directly produced by the source of the image, unlike the images coded in strongly compressed formats with loss of information, such as TIFF or JPEG or MPEG.

According to one embodiment, the method also comprises the steps of:

converting the video signal section from the raw image format into a compressed image format,
making the video signal section available in the compressed image format in a memory.

According to embodiments, the video signal can be obtained from different sources, for example from a network interface receiving a stream broadcast in streaming mode such as a television channel, or from a data storage device such as an optical disk reader, a hard disk or a flash memory module.

According to one embodiment, the method also comprises:

receiving a video stream encoded in a compressed format,
decoding the video stream to generate the video signal currently being played back.

According to one embodiment, the graphic control elements also comprise an image sharing triggering element that can be activated by the user to trigger the steps of: generating a draft message containing the selected section of the video signal, and possibly other elements, for example a text area, and

sending the message to a sharing service, for example in response to a validation signal of the draft message.

As employed here, a sharing service designates an application capable of publishing or communicating the message to one or more recipients, in a private or public manner. Sharing services that can be used in embodiments are notably electronic mail, the multimedia messaging service MMS, the online social networks such as Twitter® or Facebook® or others.

According to one embodiment, the method also comprises the step of employing a security key associated with a secure personal account of the sharing service, to share the message under a determined identity associated with the secure personal account. According one embodiment, the security key comprises an authentication token generated in accordance with an open authorization protocol OAuth. The expression open authentication protocol OAuth here designates the protocols defined by the OAuth working group of the Internet Engineering Task Force, notably in the Requests for Comment 5849, 6749 and 6750, and the changes to such protocols. These protocols are used, in certain embodiments, to broadcast the message over a social network under the identity of a member of the social network.

According to one embodiment, the invention provides a processing device for video signal, in particular a digital television network access box, the device comprising:

a video buffer memory capable of storing a video signal currently being played back,
a graphical interface generation module capable of generating a graphical interface comprising graphic control elements that can be activated in response to activation signals to control functions of the processing device,
a video mixer capable of producing a display signal for a display, the display signal representing a combination of the graphical interface originating from the generation module and of the video signal currently being played back originating from the video buffer memory,
in which the graphic control elements comprise an image capture triggering element that can be displayed on the display in combination with the video signal currently being played back and that can be activated to trigger the steps of:
selecting a section of the video signal currently being played back comprising an image displayed on the display at the time of the activation of the image capture triggering element, and
making the selected video signal section available in a memory of the processing device.

According to other embodiments, such a device can have one or more of the following features.

According to embodiments, the making available of the selected video signal section can be performed by tagging or marking the video signal section, in particular by saving section start and/or end addresses, or by copying the video signal section, possibly with format conversion of the video signal section.

According to a corresponding embodiment, the device also comprises a capture memory module and a memory copy module capable of copying the selected video signal section from the video buffer memory to the capture memory module in response to the activation of the image capture triggering element.

According to one embodiment, the device also comprises:

an input interface capable of receiving a video stream encoded in a compressed format, and
a video decoding module capable of decoding the video stream to generate the video signal currently being played back.

According to one embodiment, the graphic control elements also comprise an image sharing triggering element that can be activated by the user, and

a message generating module capable of generating a draft message containing the section of the video signal and a text area in response to an activation of the image sharing triggering element, and
of sending the message to a sharing service in response to a validation signal.

According to one embodiment, the device also comprises a profile storage module capable of storing personal data associated with a secure personal account of the sharing service, the message generating module being capable of initiating a communication with the sharing service by employing the personal data in such a way as to share the message under a determined identity associated with the secure personal account.

One idea on which the invention is based is to provide an image capture function that can be controlled by means of a graphical interface, to enable a user currently viewing a video content on a display to easily select a section that he wants to extract from this content for the purposes of sharing and/or storage. Another idea on which the invention is based is to produce this function without overloading the captured content with the graphic control elements.

Some aspects of the invention start from the idea of proposing a function for sharing contents extracted from a video signal which is easy to use. Certain aspects of the invention start from the idea of proposing such a function by means of the graphical interface of a digital television network access box, such a box being able to also offer numerous other functionalities in an integrated manner.

The invention will be better understood, and other aims, details, features and advantages thereof will become more clearly apparent from the following description of a number of particular embodiments of the invention, given solely by way of illustration and in a nonlimiting manner, with reference to the appended drawings.

In these drawings:

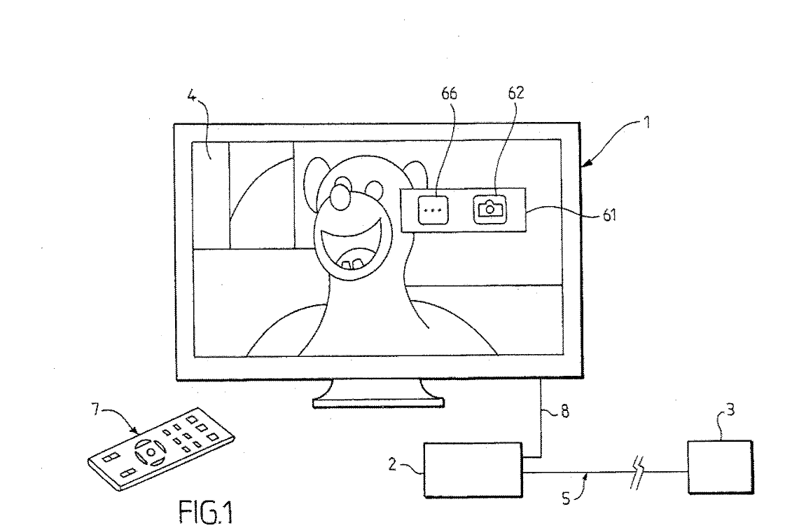

FIG. 1 is a functional schematic representation of a television and of a digital television network access box.

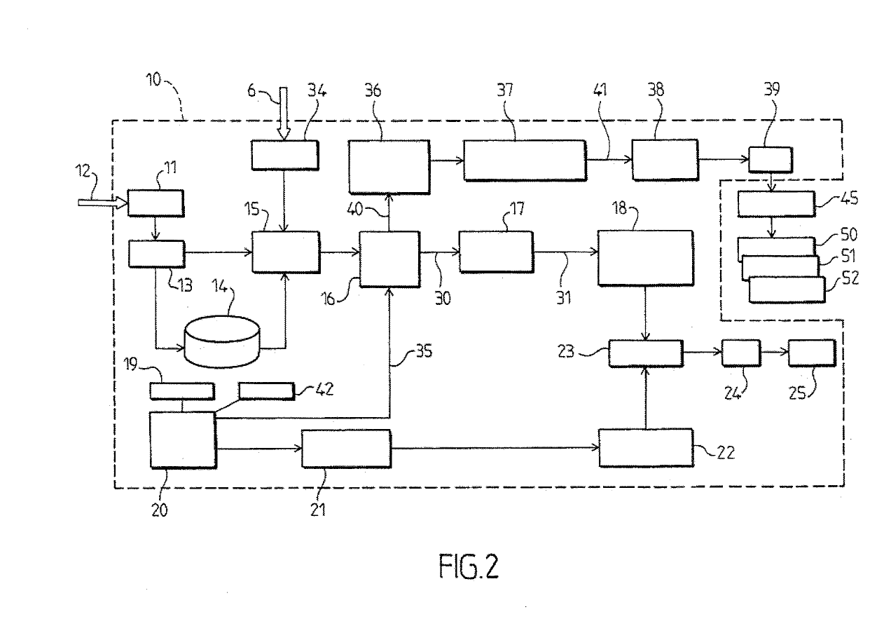

FIG. 2 is a functional schematic representation of a video signal reception and processing module that can be incorporated in the access box of FIG. 1.

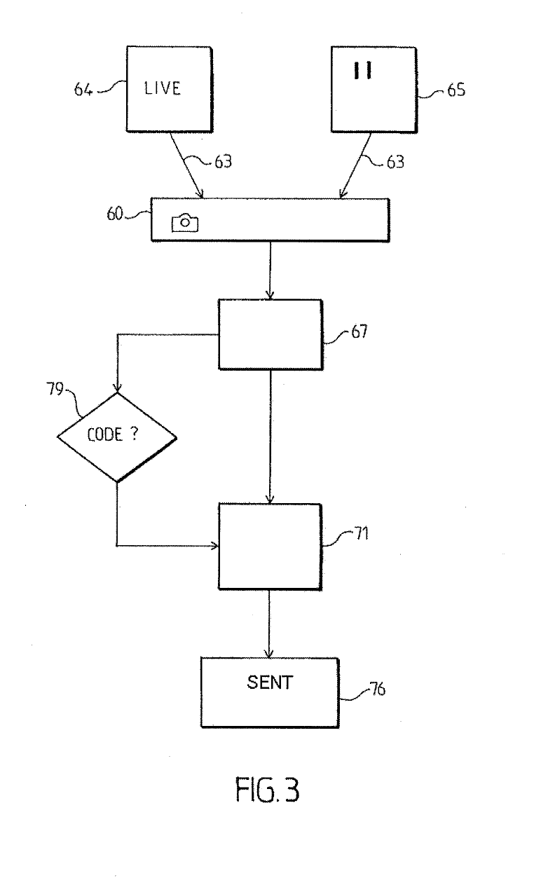

FIG. 3 is a flow diagram representing a content capture and sharing method that can be implemented with the reception and processing module of FIG. 2.

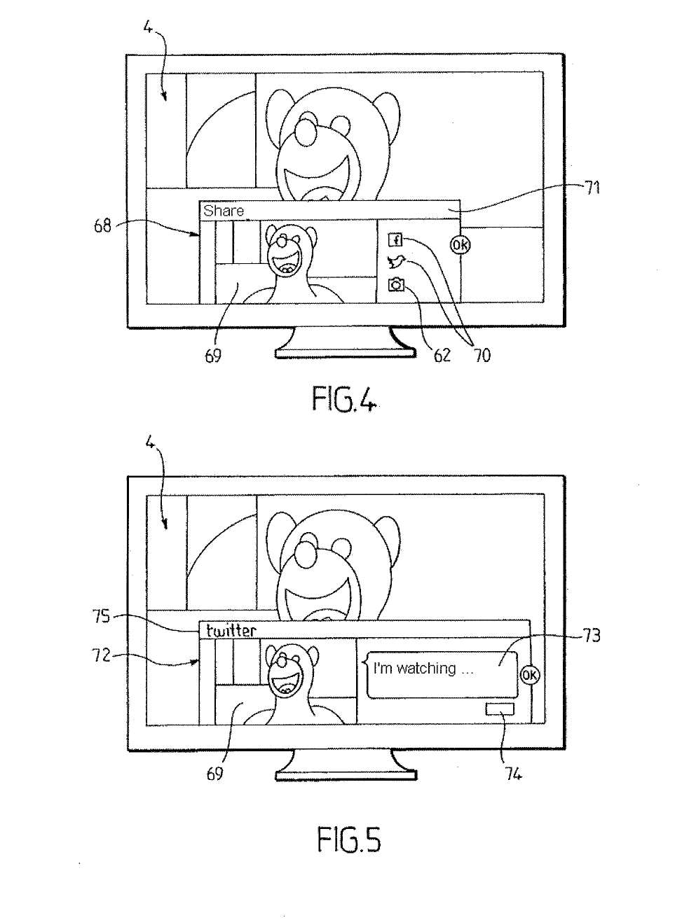

FIGS. 4 and 5 are schematic representations of a screen comprising graphical interfaces that can be used to control the method of FIG. 3.

With reference to FIG. 1, a television 1 is linked to a remote digital television distribution server 3 via an access box 2 and an access network 5. The access box 2 is, for example, placed close to the television 1 or even mechanically integrated therewith. The access network 5 can be a radio network, wired with high bit rate, for example a copper, coaxial cable or optical fibre network. The television 1 comprises a screen 4, for example a screen of large size and high resolution. The particular image represented on the screen of FIG. 1 will be described later.

One function of the access box 2 is to allow for the reception of television signals from the digital television distribution server 3. For this, the access box 2 comprises a video signal reception and processing module 10 which will now be described with reference to FIG. 2. The access box 2 may also comprise other functional modules to offer richer functionalities.

In FIG. 2, the video signal reception and processing module 10 comprises an input interface 11 for receiving a transport stream 12, for example via an optical fibre of a passive optical network. The transport stream 12 typically conveys the signals of a plurality of television channels multiplexed, for example in a DVB-C format, or non-multiplexed for example in HLS format. A demultiplexer module 13 makes it possible to extract the signal and separate these signals for them to be stored by a mass memory 14 and/or decoded by a decoder module 15.

According to one embodiment, the television signals are encoded in an MPEG 2, MPEG 4 compressed format, or any other format comprising a video track and one or more audio tracks, and possibly subtitled tracks. For this, the decoder module 15 is produced in the form of an audio and video decoder. Hereinbelow, the processing of the video signals will be described in more detail.

The mass memory 14 makes it possible to provide digital video recorder functions such as the recording of one or more programmes other than the one displayed on the screen and the recording of the programme displayed on the screen to allow navigation actions within the latter, for example rewind, play at different speeds forward or backward, pause, jump to a given point, etc. In one embodiment, the mass memory 14 is a hard disk of large capacity, for example a few hundred gigabytes.

The operation of the demultiplexer 13, of the mass memory 14 and of the decoder module 15 are driven by a control unit 20 according to the instructions given by a user by means of a remote control and a graphical interface. For this, the control unit 20 is linked to a remote control interface 19 making it possible to receive signals from a remote control 7, for example radio or infrared signals.

More specifically, the control unit 20 is capable of generating a graphical interface comprising graphic elements that can be displayed on the screen 4. These graphic elements can be selected and activated by means of the remote control 7 to control the different functions of the video signal reception and processing module 10, namely channel selection, display setup, navigation in a recorded programme and similar functions. The control unit 20, the graphical interface generated by it and the remote control 7 also make it possible to control and use image capture and image sharing functions which will be described later.

A graphical interface buffer memory module 21 is used to store the graphic elements generated by the control unit 20 in a high-level language, for example in HTML. A graphic plane generator module 22 converts the graphic elements into an image format and supplies them to an image mixer 23.

In parallel, a video buffer memory module 16 is provided to temporarily store the video stream decoded by the decoder module 15 in a raw image format. The video buffer memory module 16 operates as a queue which stores the decoded video stream for a short period, for example 1 to 5 seconds.

The video stream currently being played back 30 then passes into a reprocessing module 17 which adapts the resolution of the images according to a chosen setup state, corresponding in particular to the property of the screen 4 and the link 8 between the television 1 and the box 2, for example peritel analogue link or HDMI digital link or other. The reprocessed video stream 31 is transmitted to a graphic memory module 18 to be made available to the image mixer 23.

The image mixer 23 generates the image to be displayed on the screen 4 by combining the graphic elements of the graphical interface supplied by the graphic plane generator 22 and the video stream or streams supplied by the graphic memory module 18. According to embodiments, this combination can take the form of an overlay of windows in which the control graphic elements are above the video image or of a juxtaposition of windows or even of other forms according to the known graphical interfaces technology. The image mixer 23 thus feeds a graphic display layer memory 24 which stores the image and makes it available over a physical interface 25 that is used to link the television 1, for example an HDMI interface.

There now follows a description of an image capture function which is implemented by the video signal reception and processing module 10.

In response to the reception of an image capture instruction, the control unit 20 transmits a capture signal 35 which provokes an immediate copying of the content of the video buffer memory module 16 in a capture memory module 36, so as to retain a copy of the image 40 which was displayed on the screen at the moment of the transmission of the image capture instruction. The image 40 remains in the raw image format in the capture memory module 36, whereas it is quickly erased from the video buffer memory module 16 if the playback of the current programme continues. Thus, the image 40 is available to be used in sharing or communication applications.

Various possibilities exist for enabling the user to transmit the image capture instruction. According to a preferred embodiment, the graphical interface comprises an icon that can be activated using the remote control 7 to generate the image capture instruction. As a variant, a button dedicated to this function can be provided on the remote control 7 without involving the graphical interface. In all cases, the objective is to capture the image or one of the images which is displayed on the screen at the moment when the user triggers the transmission of the image capture instruction. For this, a relatively short response time of the control subsystem is necessary, for example less than 100 ms.

A conversion module 37 makes it possible to convert the captured image from the raw image format to a compressed format such as JPEG or TIFF and with a quality and resolution level that can be adjusted according to the requirements of the target application. The conversion module 37 stores the image 41 coded in the compressed format in a sharing memory module 38 to make the image 41 available to one or more sharing applications.

There now follows a description of an image sharing function which is implemented by the video signal reception and processing module 10.

In response to the reception of an image sharing instruction, the control unit 20 generates a draft message containing the captured image 41 in the body of the message. A network interface 39 of the video signal reception and processing module 10 finally makes it possible to transmit the message containing the captured image 41 to one or more sharing services external to the access box 2.

According to one embodiment, the control unit 20 is also linked to a messaging setup module 42 containing identification data making it possible to access personal user accounts on one or more sharing servers 50, 51 and 52 external to the access box 2. The control unit 20 uses the identification data to transmit the message to a sharing server in order for the message to be published or broadcast under the identity corresponding to the personal user account. Identification data that can be used for this purpose include, for example, subscriber identifiers with an Internet access provider, subscriber identifiers with a mobile telephony operator (for example SIM card) or subscriber identifiers with a social network, notably user name and password or authentication token generated according to an open authorization protocol OAuth.

With reference to FIG. 3, there now follows a description of a method for controlling the abovementioned image capture and sharing functions using a graphical interface that can be displayed on a television.

In a capture waiting state 60, a graphic capture menu 61 is displayed on the screen. The graphic capture menu 61 comprises a capture icon 62, for example representing a camera, and possibly other icons. The screen 4 of FIG. 1 shows an example of the graphic capture menu 61 displayed overlaid on a televisual content currently being played back. Alternatively, the graphic capture menu 61 can be positioned differently, for example in the form of a top strip or a side panel in relation to the televisual content currently being played back.

The graphic capture menu 61 could be displayed permanently. Preferably, to avoid overloading the image, this menu is displayed contextually in response to an action 63 on the part of the user on the remote control 7, for example pressing an “action” button. As can be seen in FIG. 3, the capture waiting state 60 can thus be reached by starting from a real time playback state 64 of the televisual content or by starting from a pause state 65 of the televisual content, that is to say, a frozen image.

According to one embodiment, the graphic capture menu 61 contains, in combination with the capture icon 62, other graphic elements, represented symbolically with the number 66, making it possible to control the navigation in the televisual content currently being played back. In practice, capturing a live image while viewing a programme can prove difficult in certain rapid sequences of the programme. The ergonomics of the system are therefore enhanced when the user can easily, after having passed the image that he wanted to capture, rewind in the programme to capture the image during a second viewing, notably at reduced speed. The activation of the capture icon 62 provokes the transmission of the capture signal 35 and switches the graphical interface to a sharing waiting state 67.

In the sharing waiting state 67, a graphic sharing menu 68 is displayed on the screen. The graphic sharing menu 68 comprises a reproduction of the image actually captured 69, to enable the user to check the result of his previous action, and sharing service icons 70, to enable the user to select a service with which he wants to communicate the captured image, and possibly other icons. In one embodiment, the capture icon 62 is also available to make it possible to immediately capture another image of the programme currently being played back if the result of the first capture is unsatisfactory.

The screen 4 of FIG. 4 shows an example of the graphic sharing menu 68 displayed overlaid on the televisual content currently being played back. Here, two sharing service icons 70 are provided to select a sharing either over the social network Facebook®, or over the social network Twitter®. These examples are purely illustrative. A top strip 71 of the graphic sharing menu 68 can be provided to enhance the legibility of the graphical interface.

The activation of a sharing service icon 70 leads to the generation of a draft message preconfigured to be broadcast over the selected sharing service and switches the graphical interface to a sending waiting state 71.

In the sending waiting state 71, a graphic draft message menu 72 is displayed on the screen. The graphic draft message menu 72 again includes the reproduction of the captured image 69, which is included in the draft message that is to be broadcast, a text area 73, precompleted and/or to be completed by the user using a keypad of the remote control 7 and/or a keyboard displayed on the screen (not represented) and a sending icon 74, to enable the user to finally send the message to the chosen sharing service.

The screen 4 of FIG. 5 shows an example of the graphic draft message menu 72 displayed overlaid on the televisual content currently being played back. A top strip 75 of the graphic draft message menu 72 can be provided to enhance the legibility of the graphical interface by explicitly mentioning the sharing service for which the draft message is configured.

According to one embodiment, each sharing service that can be selected is associated with an accepted image file size parameter stored in a memory. Thus, the conversion module 37 adjusts the image quality according to the selected sharing service so that the captured image 69 inserted in the message does not exceed the accepted image file size.

According to another embodiment, the graphical interface comprises an image size selection menu enabling the user to select parameters of the captured image 69 inserted in the message, for example resolution or quality or file size, among a number of possible values. This selection menu can be displayed, for example, in the sending waiting state 71.

The activation of the sending icon 74 leads to the broadcasting of the message over the selected sharing service and switches the graphical interface to a sending confirmation state 76, in which a brief confirmation message is displayed on the screen to confirm to the user that the message has been successfully sent.

In the different graphic menus represented, the activation of an icon can be implemented in numerous ways, as is elsewhere known in the graphical interfaces technology, for example by clicking on an icon, by pushing an activation button of the remote control 7, by selecting the icon and then clicking on another activation icon, for example an icon marked “OK”, or other ways. According to one embodiment, the remote control 7 comprises a return key which makes it possible to cancel the current operation.

In the above, it has been assumed that all the user data making it possible to configure the sending of the message were available in the messaging setup module 42, namely that an authenticated link was able to be set up by the access box 2 with the server 51 of the Twitter® messaging service without the user needing to enter an identifier or a password. However, such a preconfiguration is not mandatory. In the case where the control unit 20 detects that the messaging setup module 42 does not contain the data making it possible to set up an authenticated link with the sharing service selected in the state 67, a graphic input menu is displayed on the screen in the step 79, to enable the user to input the missing data, for example identifier and/or a password. After inputting these data, the graphical interface reaches the abovementioned sending waiting state 71.

In another embodiment, the access box 2 is configured to transmit the message to an intermediate server 45 in which the abovementioned identification data are stored, so that the intermediate server 45 retransmits the message containing the captured image to the sharing server 50, 51 or 52 in order for the message to be published or broadcast under the identity corresponding to the personal user account. This embodiment makes it possible to centrally store the identification data making it possible to access the personal user account, notably on an intermediate server 45 placed under the control of the service provider who is using the digital television distribution server 3. In one embodiment, the service provider makes a web portal available to its subscribers that makes it possible to configure the abovementioned identification data on the intermediate server 45. Thus, the management of these identification data, which may include sensitive data, can be performed in a more secure manner.

In an embodiment employing the intermediate server 45, the draft message downloaded to the intermediate server 45 by the module 10 contains the captured image in the raw image format. A reprocessing of the captured image can then be performed by the intermediate server 45 before the message is communicated over the selected sharing service. Such a reprocessing may comprise various operations, for example a conversion of the image into a compressed format to satisfy a file size criterion and/or the insertion of graphic elements into the image, notably an advertising strip.

Functions for capturing and sharing a video sequence can be designed in a way similar to the image capture and sharing functions described above. For this, a graphic control element that is identical to or distinct from the capture icon 62 can be provided to mark the end of the video sequence to be captured.

The embodiments described above relate to television signals preferentially comprising an audio track. However, similar methods and devices can be employed to process video signals with no audio track.

In one embodiment, the access box 2 combines the video signal reception and processing module 10 with other functionalities such as Internet access functionalities, IP routing, address translation, firewall functionalities, wired Ethernet and/or wireless Wifi local area network management functionalities, telephony over IP functionalities, functionalities for storing and playing back and writing audio and video media according to different codecs, etc. This list is not exhaustive.

According to one embodiment, the access box 2 implements a file manager making it possible to transfer the image stored in the sharing memory module 38 to other storage devices, notably the mass memory 14 or the memory of other appliances connected to the access box 2 via the wired or wireless local area network, for example computers, telephones, smartphones, digital tablets, or other appliances provided with a display device. According to one embodiment, the functionalities of the remote control 7 are fulfilled by such an appliance connected to the access box 2, for example a digital tablet.

In one embodiment, the access box 2 is capable of accessing video contents from a plurality of sources, for example from a mass storage device of multimedia centre type and from the interface 11 linked to the television server 3. Preferably in this case, the video signal reception and processing module 10 is arranged in such a way as to be able to be switched to these different sources in order to, each time, implement image capture functionalities from the source concerned and captured image sharing functionalities. Thus, in FIG. 2, the video signal reception and processing module 10 comprises an interface for a local area network 34, wired or wireless for example, making it possible to supply to the decoder module 15 a video content to be decoded 6 originating from an external storage device, for example a USB key or personal computer.

According to embodiments, the video signal reception and processing module 10 described can be implemented in appliances likely to receive video streams other than the access box 2, for example a mobile telephone, a digital tablet or a personal computer linked to the Internet. The video signal reception and processing module 10 enables the user to rapidly and reactively publish images or short citations of video contents, notably of televised programmes broadcast live, as well as associated comments on sharing services such as social networks, chat forums on the web or messaging services.

Some of the elements represented, notably the components of the video signal reception and processing module, can be produced in different forms, in a unitary or distributed manner, by means of hardware and/or software components. Hardware components that can be used are application-specific integrated circuits ASIC, programmable logic arrays FPGA or microprocessors. Software components can be written in different programming languages, for example C, C++, Java or VHDL. This list is not exhaustive.

Although the invention has been described in relation to a number of particular embodiments, it is obvious that it is in no way limited thereto and that it comprises all the technical equivalents of the means described as well as their combinations if the latter fall within the framework of the invention.

The use of the verb “comprise” or “include” and its conjugated forms does not preclude the presence of elements or steps other than those mentioned in a claim. The use of the indefinite article “a” or “an” for an element or a step does not preclude, unless otherwise stipulated, the presence of a plurality of such elements or steps. A number of means or modules may be represented by one and the same physical element.

In the claims, any reference sign between parentheses should not be interpreted as a limitation on the claim.

1. Method for processing a video signal, comprising:
generating a graphical interface comprising graphic control elements that can be activated in response to activation signals, the graphic control elements comprising an image capture triggering element,
producing, for a display, a display signal representing a combination of the graphical interface and of a video signal currently being played back,
selecting a section of the video signal currently being played back in response to an activation of the image capture triggering element, the selected section of the video signal comprising an image of the video signal displayed on the display at the time of the activation of the image capture triggering element,
making the selected video signal section available in a memory.

2. Method according to claim 1, in which the graphic control elements also comprise an image sharing triggering element that can be activated by the user to trigger the steps of:
generating a draft message containing the section of the video signal, and sending the message to a sharing service.

3. Method according to claim 1, in which the draft message generated also comprises a text area.

4. Method according to claim 2, also comprising the step of employing a security key associated with a secure personal account of the sharing service to share the message under a determined identity associated with the secure personal account.

5. Method according to claim 4, in which the security key comprises an authentication token generated in accordance with an open authorization protocol OAuth.

6. Method according to claim 1, in which the selected video signal section consists of an image displayed on the display at the time of the activation of the image capture triggering element.

7. Method according to claim 6, in which the selected video signal section comprises a sequence of images beginning at an image displayed on the display at the time of the activation of the image capture triggering element.

8. Method according to claim 7, in which an audio sequence associated with the sequence of images is also selected in response to the activation of the image capture triggering element and made available in a memory.

9. Method according to claim 1, in which the selected video signal section is made available in the memory in a raw image format.

10. Method according to claim 9, also comprising the steps of:
converting the video signal section from the raw image format into a compressed image format,
making the video signal section available in the compressed image format in a memory.

11. Method according to claim 1, also comprising:
receiving a video stream encoded in a compressed format,
decoding the video stream to generate the video signal currently being played back.

12. Processing device for video signal, comprising:
a video buffer memory capable of storing a video signal currently being played back,
a graphical interface generation module capable of generating a graphical interface comprising graphic control elements that can be activated in response to activation signals to control functions of the processing device,
a video mixer capable of producing a display signal for a display, the display signal representing a combination of the graphical interface originating from the generation module and of the video signal currently being played back originating from the video buffer memory,
in which the graphic control elements comprise an image capture triggering element that can be displayed on the display in combination with the video signal currently being played back and that can be activated to trigger the steps of:
selecting a section of the video signal currently being played back comprising an image displayed on the display at the time of the activation of the image capture triggering element, and
making the selected video signal section available in a memory of the processing device.

13. Processing device according to claim 12, also comprising a capture memory module and a memory copy module capable of copying the selected video signal section from the video buffer memory to the capture memory module in response to the activation of the image capture triggering element.

14. Processing device according claim 12, also comprising:
an input interface capable of receiving a video stream encoded in a compressed format, and
a video decoding module capable of decoding the video stream to generate the video signal currently being played back.

15. Processing device according to claim 12, in which the graphic control elements also comprise an image sharing triggering element that can be activated by the user, and
a message generating module capable of generating a draft message containing the section of the video signal and a text area in response to an activation of the image sharing triggering element and of sending the message to a sharing service in response to a validation signal.

16. Processing device according to claim 15, also comprising a profile storage module capable of storing personal data associated with a secure personal account of the sharing service, the message generating module being capable of initiating a communication with the sharing service by employing the personal data in such a way as to share the message under a determined identity associated with the secure personal account.

17. Method according to claim 3, also comprising the step of employing a security key associated with a secure personal account of the sharing service to share the message under a determined identity associated with the secure personal account.

18. Method according to claim 2, in which the selected video signal section consists of an image displayed on the display at the time of the activation of the image capture triggering element.

19. Method according to claim 3, in which the selected video signal section consists of an image displayed on the display at the time of the activation of the image capture triggering element.

20. Method according to claim 4, in which the selected video signal section consists of an image displayed on the display at the time of the activation of the image capture triggering element.
